(19) United States
(12) Patent Application Publication
(10) Pub. No.: US 2003/0208841 A1
(43) Pub. Date: Nov. 13, 2003

(54) Bath fitting and mounting thereof

(76) Inventor: Kipley Roydon Marks, St. Heliers (NZ)

Correspondence Address: YOUNG & THOMPSON, 745 SOUTH 23RD STREET 2ND FLOOR, ARLINGTON, VA, 22202

(21) Appl. No.: 10/259,737

(22) Filed: Sep. 30, 2002

(30) Foreign Application Priority Data
May 9, 2002 (AU) PS2211

(51) Int. Cl. A61H 33/04

(52) U.S. Cl. 4/541.6

(57) ABSTRACT

A self draining bath fitting for use in bathing installations including baths, showers, spa baths or jacuzzis. A flow path is provided through the fitting to allow liquid to drain from the fitting under the influence of gravity. A mounting for a bath fitting is also provided having a face plate with a rear flexible membrane seal which is concealed behind the faceplate, and a mounting nut provided on the body of the fitting behind the bath wall. Tightening the nut secures the fitting about an aperture in the bath wall. The faceplate can be removed to allow access to the fitting for inspection and maintenance purposes.

### FIELD OF THE INVENTION

This invention relates to bath fittings and to methods and apparatus for mounting such fittings in the wall of a bath. Reference to “bath” in this document includes bathing installations generally such as swimming pools, spa baths and shower installations.

### BACKGROUND OF THE INVENTION

Bath fittings such as water inlet or outlet assemblies are typically glued in place or attached using fasteners, and a sealant such as silicone sealant is placed about surfaces of the assembly so as to create a water tight seal between the assembly and the wall of the bath.

Use of silicone sealants can be untidy and result in a messy appearance, and sealing contact is not always satisfactorily made. Also, with a spa system for example, after use of the spa system water can remain in the spa jet and feeder conduits, which can create problems. Primarily, there is a potential health or hygiene problem with the water that remains stagnant in the conduits for a period of time. Also, deposits of black slime can build up on the internal components such as the pipework and jets. This is often flushed out when the spa system is operated. These deposits detract from the cleanliness of the bath and are distressing for the user to see.

### OBJECT OF THE INVENTION

It is an object of the present invention to provide a bath fitting or a method or apparatus for mounting such a fitting and/or draining such fittings and pipework which will at least go some way toward overcoming disadvantages with known constructions, or which will at least provide the public with a useful choice.

### SUMMARY OF THE INVENTION

In one aspect the invention consists in a bath fitting for location in the wall of a bath, the fitting having

a first liquid transfer opening which is open to the bath,

a second liquid transfer opening for connection to a liquid transfer conduit, and

draining means.

The draining means provide a liquid flow path between the second opening and the first opening so that any liquid in the body drains from the second opening to the first opening for delivery through the first opening into the bath.

The fitting preferably comprises a spa jet whereby the first opening comprises an outlet from the jet, and the second opening comprises one of a water supply inlet or an air supply inlet or both.

Alternatively, the fitting comprises a suction fitting, the first opening comprising an inlet to the suction fitting and a second opening comprising an outlet from the fitting.

The draining means also preferably include at least one sloped nozzle between the first and second openings.

The second opening preferably includes a connection portion which includes a sloped surface to direct water in the connection portion toward the first opening.

In one embodiment a plurality of fittings are provided as part of a liquid delivering system, the system including liquid transfer conduits provided between fittings, the conduits having an apex region that is vertically above the second opening of the fitting whereby liquid in the conduits drains therefrom through the fittings.

In another aspect the invention consists in a bath fitting for mounting in a wall of a bath, the fitting including

a body,

a front shoulder moveable relative to the body provided on the body, the shoulder adapted to abut a rear surface of the wall,

a face plate connectable to the body, and

the face plate having a rear shoulder adapted to contact a front surface of the wall.

The rear shoulder on the faceplate preferably has a seal thereon, the seal being in use located between the shoulder and the front of the wall to thereby provide a seal between the assembly and the wall. The seal preferably comprises a flexible membrane seal (such as an O-ring) and is not visible to a user within the bath or pool.

The front shoulder is preferably provided on a moveable mounting member, moveable relative to the body, the member including fixing means whereby the member can be moved relative to the body to securely engage the assembly relative to the wall.

The fixing means preferably comprises a thread on the moveable mounting member and a complimentary thread on a surface of the body whereby the mounting member can be rotated relative to the body to firmly secure the assembly to the wall.

Rotation of the fixing means relative to the body clamps the front shoulder and the rear shoulder on the faceplate securely about the periphery of the aperture in the wall.

In a further aspect the invention consists in a method of mounting a bath fitting according to any of the preceding statements of invention in a wall of the bath using an aperture in the wall, the method including the steps of

positioning the body so that the front shoulder is adjacent to the rear surface of the wall,

placing the face plate so that the rear shoulder is adjacent to the front surface of the wall,

connecting the face plate to the body, and

moving the front shoulder toward the wall to thereby fix the fitting to the wall.

The method preferably includes the step of rotating the front shoulder relative to the body and relative to the wall to move the front shoulder toward the wall. The method also includes the step of forming a hole in the wall.

The face plate is preferably rotated relative to the body to engage the face plate with the body.

To those skilled in the art to which the invention relates, many changes in constructions and widely different embodiments and applications of the invention will suggest themselves without departing from the scope of the invention as defined in the appended claims. The disclosure and descriptions herein are purely illustrative and are not intended to be in any sense limiting.

### DRAWING DESCRIPTION

The invention consists of the foregoing and also envisages constructions of which the following gives examples only.

One presently preferred embodiment of the invention will now be described with reference to the accompanying drawings, wherein;

FIG. 1 is a side elevation in cross-section of a spa jet according to the invention mounted in an aperture in a wall of a bath.

FIG. 2 is a front elevation of the body of the spa jet of FIG. 1 i.e. this figure does not include the eyeball mount or mounting apparatus of the assembly.

FIG. 3 is a side elevation in cross-section of a suction drainage fitting according to the invention mounted in a wall of a bath.

### DETAILED DESCRIPTION OF PREFERRED EMBODIMENT

The invention provides a bath fitting which has the feature of being self draining. Therefore, the bath fitting has a first opening or port through which water can enter the fitting and a second opening or port through which water can exit the fitting. The fitting is designed to be placed within an aperture in a wall of a bath, and depending upon whether the fitting is one which is used to remove water from the bath, or to provide water to the bath, the openings may be provided within the bath, or behind the wall of the bath. Therefore, if the fitting is a water inlet fitting, for example a spa jet, then the inlet to the fitting would be located behind the wall of the bath and adapted to be attached to some form of water supplying conduit, and the outlet for example provided in a jet fitting, will be provided within the bath, or at least within the wall of the bath. On the other hand, if the fitting is one which is used to remove liquid from the bath installation, for example a suction fitting, then the inlet to that fitting will be within the bath, and the outlet will be behind the wall of the bath. The fitting is generally adapted to be mounted in a non-horizontal wall of the bath, and preferably a wall which is substantially vertical. The fitting has draining means so that it self drains. Therefore, there is a continuous path from one opening to the other that facilitates drainage of liquid from the fitting into the bath.

The invention also provides a mounting assembly for a bath fitting. The fitting is one which is mounted within the wall of a bath. The fitting includes a body having a moveable shoulder adapted to contact a rear surface of the bath wall. A face plate is also provided having sealing means to seal against a front surface of the wall and means to engage the face plate with the body.

The invention also provides a method whereby the body may be positioned relative to the aperture from the rear side of the wall, the face plate may then be engaged with the body from the front side of the wall, and the shoulder may be moved to securely fasten the assembly to the wall and make sealing contact between the body and the wall.

Reference will now be made below to specific examples of bath fittings which illustrate the invention(s). The examples provided relate to a spa jet and a suction unit for a spa bath or spa pool. It will be understood by readers who are skilled in the art to which the invention relates that these are provided as examples only, and the invention is applicable to a number of other bath fittings. Such further fittings include for example water inlets to a bath and swimming pool which are not specifically spa jets or spa nozzles and water outlets which are not necessarily intended to be used in a spa, jacuzzi or whirlpool installation. Furthermore, the mounting apparatus and method of the invention may be applied to other fittings which do not involve transfer of liquids into or out of a bath installation. For example, the mounting methods and apparatus could apply to tapware, shower heads, soap dishes or trays and other fittings which may commonly be used in bath installations.

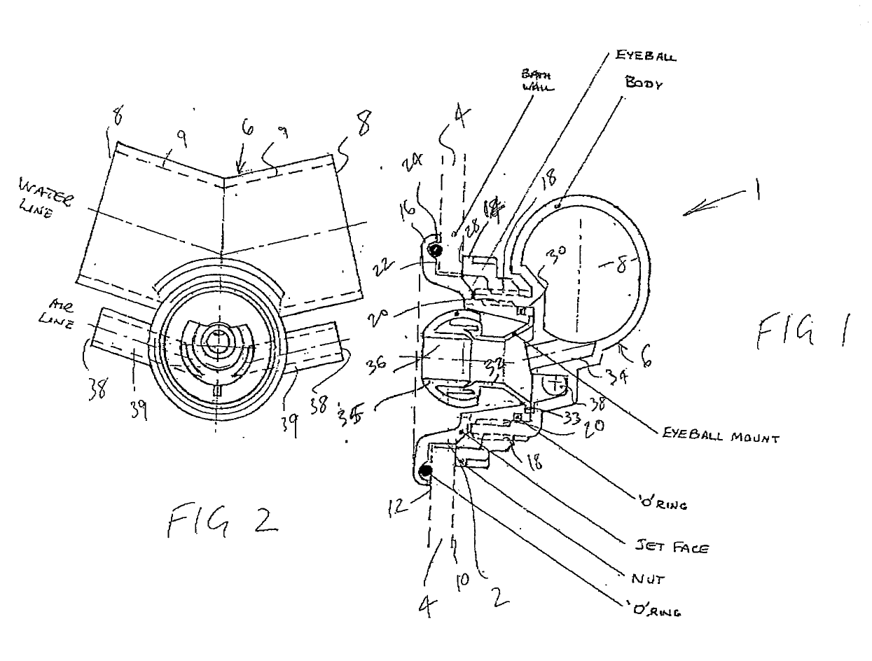

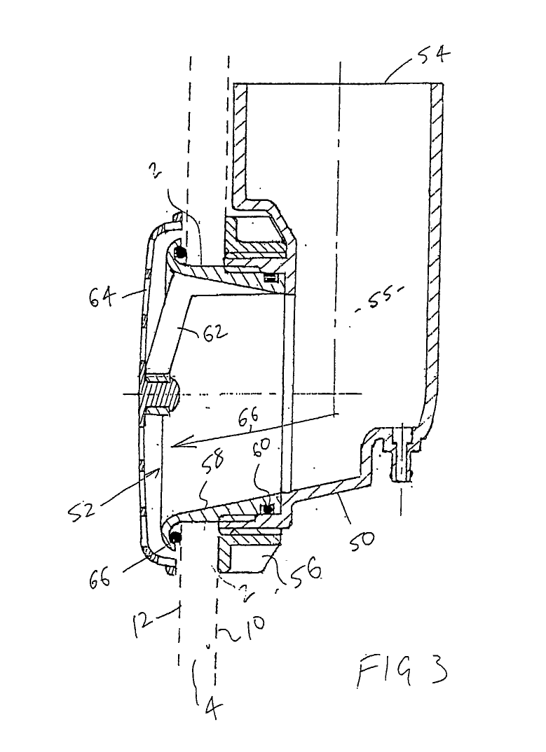

Referring to FIGS. 1 and 2, a spa jet assembly is shown generally referenced 1. The assembly is mounted in an aperture 2 of a wall 4 of a bath.

The jet assembly has a body 6 which includes at least one water inlet 8 and air inlet 38.

As can be seen with reference to FIG. 2, the inlets 8 and 38 each lead to a tube or conduit which slopes downwardly from the inlet toward the remainder of the assembly including the outlet. In the preferred form, there are typically two inlets 8 and when they are joined together they become part of the water line that typically continues about an outer surface 10 of the wall 4 (i.e. behind the bath wall 4) in order to supply water to a number of jet assemblies. The water line to which the inlets 8 are connected is supplied with water under pressure from a pump in the known way. The last jet assembly which is supplied with water in this fashion may be a specially moulded unit which has only one water inlet 8, or could alternatively comprise a unit such as that shown in FIGS. 1 and 2, but which has the other inlet 8 stopped. Therefore, one of the inlets 8 is connected to the water supply line, and the other is sealed for example using a resilient bung, a threaded cap, or some other form of stopper which is substantially water tight.

The body 6 has mounting or attachment means for mounting the assembly about the aperture 2, and more particularly mounts the apparatus by clamping it between inner surface 10, and an outer surface 12 of wall 4. The attachment or mounting means comprise a nut 14 and a faceplate 16. The nut 14 is connected to a surface 18 of the body, and the faceplate 16 is connected to a surface 20 of the body. The nut 14 and faceplate 16 are connected to surfaces 18 and 20 by corresponding threads in the preferred embodiment. Therefore, the assembly is easily fixed to the wall by providing the body 6 in a suitable position adjacent to outer surface 10 at the rear of the wall, then placing faceplate 16 through the aperture 2 from the front of the wall such that it may threadably engaged with region 20 of the body, and then the faceplate can be rotated so as to engage it with the body, so that the shoulder 22, and thus O-ring 24 can be moved axially to place them adjacent to the inner surface 12 of the wall. As can be seen from the drawing, O-ring 24 provides a seal which contacts suface 12 to prevent water from the bath from escaping through the aperture 2. The shoulder 28 on nut 14 abuts the outer surface 10 of the wall, and the nut may be rotated relative to the body in the wall to move the nut axially to securely fasten the assembly about (i.e. within) the aperture 2. The faceplate 16 is sealably connected to the body by O-ring 30.

As a further part of the assembly, an eyeball mount 32 is provided, and this is captured between the body and the inner most end of the faceplate 16, so it will be seen that the apparatus is easily assembled, and disassembled, by simply removing the faceplate 16 and in this way the eyeball mount 32 is also easily removed to clear any obstructions or blockages or for servicing. The mount 32 includes a directional nozzle 35 which can be swivelled by a user in the known way relative to the mount 32 in order to direct the outlet jet of water or water and entrained air, in a desired direction. Immediately up stream of the eyeball mount 32 is a nozzle 34 and an air inlet 38, that connects the outlet 36 with the inlet 8. In use, the flow of water into the eyeball mount creates a venturi effect, i.e. creates a region of low pressure and this entrains air from air inlet 38 into the water flow (if a mixture of air and water is desired by a user) so that water and entrained air flows out the outlet 36. Alternatively, the user may simply wish to have water flow through outlet 36, and this is achieved by a user closing off the air supply in the known way.

The connections 9 and 39, for the inlets 8 and 38 respectively, are angled downwardly toward the outlet, but generally perpendicular to the outlet. Therefore, a flow path is provided so that water in or about the inlet connections flows toward the outlet of the apparatus. Drainage from the air connection 39 is highly desirable because water can sometimes enter the air line, for example due to a blocked jet. Also, if the apertures between the inlets of adjacent jets are curved or otherwise upwardly directed so as to form a general vertically oriented arc between adjacent inlets, then all water in the conduit system will be drained toward jet units (and/or one or more suction units, as will be described further below). This means that the inlets are self draining, and the connecting conduits may also be self draining. Furthermore, it will be seen that there is a nozzle 34 between the inlet region and the outlet. This also sloped (at approximately 15° in the preferred embodiment) toward the outlet. In this way, any water within the housing is also drained under the influence of gravity by this nozzle towards the eyeball mount 32. From here, the water flows into the directional nozzle 35, and then out of the outlet 36 and into the bath. One or more small apertures are preferably provided in the periphery of the eyeball mount base at or near the lowest part of the base, so that water is not trapped at the base of the mount, but instead drains along the face plate and into the bath.

If water is present in the air line or in the air inlet connection 39, then this water drains down the sloping connection 39 (refer FIG. 2) and into the eyeball mount 32. From there, the water either flows into the directional nozzle 35 and out of outlet 36 into the bath, or through aperture 33 provided in the rear of the eyeball mount where the eyeball mount is captured between the body 6 and the rear of the faceplate 16. The water is thus free to flow through aperture 33 and into the bath. Therefore a flow path between the inlet(s) and outlet is provided so that the assembly as a whole is generally self draining.

It will be seen that the O-ring 24 provides an effective seal against the bath wall and this eliminates the need for sealants which cure after assembly to the bath wall. The O-ring is difficult to see by a user of the bath or pool since it sits behind the flange or shoulder of the faceplate. Therefore, an aesthetically pleasing appearance is provided to the assembly while a secure sealing engagement is still made.

Finally, the nut 14 on the body allows a secure mechanical engagement to be made between the bath wall and the assembly without requiring any separate fasteners such as screws, glue etc. The nut 14 also allows different wall thicknesses to be accommodated.

Referring now to FIG. 3, a suction drainage unit, such as that commonly used in a spa bath installation to remove water from the bath so that the water can be recirculated by a pump is shown. The fitting includes a body 50 having an inlet 52 and an outlet 54. Outlet 54 is usually attached to conduit which leads directly or indirectly to a pump inlet. The body 50 has a moveable nut 56 which is threadably connected to an outer surface of the body and may be rotated relative to the body using the thread to contact rear surface 10 of the bath wall 4. The inlet 52 is partly defined by a face plate 58 and a seal in the form of an O-ring 60 provides a seal between the face plate and the body. One or more flanges 62 provide a connection between the face plate and a suction cover 64 which is appropriately apertured to allow liquid to enter the inlet. The shape of cover 64 is intended to provide some protection to users of the bath.

Installation of the suction unit of FIG. 3 is substantially the same as that described with the spa nozzle example above. That is to say, the body 50 is placed adjacent to the aperture 2 next to the rear surface 10 of the bath wall 4, then the face plate is inserted from the front surface 12 of the wall and threadably connected to the body. The nut 56 is then rotated to form a secure mechanical and sealing connection so that O-ring 66 of the face plate sealably contacts the inner surface 12 of the bath wall 4.

As illustrated in FIG. 3, the suction installation is intended to be mounted on a wall which is not horizontal, and which is preferably substantially vertical. The outlet is vertically displaced from the inlet such that there is a flow path between the outlet and the inlet which is contoured by means of the slope generally indicated by arrow 66 which runs parallel to the base walls of the body 50 and the face plate 58 so that a continuous self draining flow path is provided for liquid which may remain in the body when the bath is emptied. FIG. 3 may also comprise a plan view in cross-section, the inlet being conical or part-conical in form to provide the required slope for drainage.

Thus, if there is liquid in the body of the suction fitting, for example in the outlet connection portion 55 immediately after use, then the liquid will tend to travel toward sloped base wall 50. From there, it will travel along the wall 50 to the inlet 52 of the unit. It then drains from inlet 52 into the bath.

The invention also includes an installation that uses self-draining fittings such as the spa jet fitting and suction fitting described above. The installation is formed by air and liquid connections between the fittings being generally arcuate or peaked, so that there is an “air bell” in the conduits between fittings as the bath is filled with water. In this way, a large part of each conduit is only exposed to water when the installation is in use i.e. when water is being circulated through the system. When the installation is not in use, the water drains from it, through the fittings, for disposal through the bath waste drain. This installation has the advantage that conduits and fittings do not retain liquid, and are exposed to liquid only when in use, so algae, and other problems associated with exposure to liquid, are much less likely to occur or will take longer to occur.

The invention will be seen to include a number of novel or advantageous features including but not limited to those listed below:

(a) A flexible membrane seal, such as an O-ring, is fitted behind the front face or flange of the fitting assembly to seal on the front face of the bath wall.

(b) A shouldered nut is provided on the body of the fitting so that tightening of the nut serves to retain the fitting within the hole in the bath wall and prevent axial movement of the installed fitting relative to the wall. There is a significant benefit in the nut running on the body rather than on the front face member which screws into the body. This is because unscrewing the front face from the wall of the bath is possible without disturbing the nut. This allows total servicing of the product i.e. replacement of the jet face, eyeball, and both O-rings from the front wall of the bath. This is not possible if the nut runs on the jet face.

(c) There is a water ejection nozzle in the spa jet which allows drainage from the pipework into the air mixing chamber and is inclined relative to the wall face, thus enabling complete draining of the pipework and jet body prior to the mixing chamber.

(d) Draining of the mixing chamber by virtue of the conical or part-conical shape of the chamber extending into the bath.

(e) Draining of the suction fitting by virtue of the conical or part-conical shape of the internal chamber extending into the bath.

(f) Connecting pipework feeding to and from the fittings is inclined at an angle to the horizontal creating a volume of trapped air in the pipework between jets. This then prevents water entering the pipework when the bath is filled, thus keeping the pipework dry unless the spa system i.e. the pump is turned on, forcing water through the pipework and displacing the trapped air. Sloped pipework also provides for total draining of the pipe into the jets each side of the highest point of the pipe.

Throughout the description and claims of this specification the word “comprise” and variations of that word, such as “comprises” and “comprising”, are not intended to exclude other additives, components, integers or steps.

1. A bath fitting for location in the wall of a bath, the fitting having
a first liquid transfer opening which is open to the bath,
a second liquid transfer opening for connection to a liquid transfer conduit, and
draining means.
The draining means provide a liquid flow path between the second opening and the first opening so that any liquid in the body drains from the second opening to the first opening for delivery through the first opening into the bath.

2. A bath fitting as claimed in claim 1 comprising a spa jet whereby the first opening comprises an outlet from the jet, and the second opening comprises one of a water supply inlet or an air supply inlet.

3. A bath fitting as claimed in claim 1 comprising a suction fitting, the first opening comprising an inlet to the suction fitting and a second opening comprising an outlet from the fitting.

4. A bath fitting as claimed in claim 1 wherein the draining means also preferably include at least one sloped nozzle between the first and second openings.

5. A bath fitting as claimed in claim 1 wherein the second liquid transfer opening includes a connection portion which includes a sloped surface to direct water in the connection portion toward the first opening.

6. A liquid delivery system for a bathing installation, the system including a plurality of liquid delivery fittings, at least one of the liquid delivery fittings being a bath fitting as claimed in claim 1, the system further including at least one liquid transfer conduit provided between the bath fitting and another liquid delivery fitting, the conduit having an apex region that is vertically above the second opening of the bath fitting whereby liquid in the conduit drains from the conduit through the bath fitting.

7. A bath fitting for mounting in a wall of a bath, the fitting including
a body,
a front shoulder moveable relative to the body provided on the body, the shoulder adapted to abut a rear surface of the wall,
a face plate connectable to the body, and
the face plate having a rear shoulder adapted to contact a front surface of the wall.

8. A bath fitting as claimed in claim 7 wherein the rear shoulder on the faceplate preferably has a seal thereon, the seal being in use located between the shoulder and the front of the wall to thereby provide a seal between the assembly and the wall.

9. A bath fitting as claimed in claim 8 wherein the seal preferably comprises a flexible membrane seal.

10. A bath fitting as claimed in claim 8 wherein a preferably the seal is not visible to a user within the bath or pool.

11. A bath fitting as claimed in claim 7 wherein a front shoulder is preferably provided on a moveable mounting member, moveable relative to the body, the member including fixing means whereby the member can be moved relative to the body to securely engage the assembly relative to the wall.

12. A bath fitting as claimed in claim 11 wherein the fixing means preferably comprises a thread on the moveable mounting member and a complimentary thread on a surface of the body whereby the mounting member can be rotated relative to the body to firmly secure the assembly to the wall.

13. A bath fitting as claimed in claim 11 wherein rotation of the fixing means relative to the body clamps the front shoulder and the rear shoulder on the faceplate securely about the periphery of the aperture in the wall.

14. A method of mounting a bath fitting according to claim 7 in a wall of the bath about an aperture in the wall, the method including the steps of
positioning the body so that the front shoulder is adjacent to the rear surface of the wall,
placing the face plate so that the rear shoulder is adjacent to the front surface of the wall,
connecting the face plate to the body, and
moving the front shoulder toward the wall to thereby fix the fitting to the wall.

15. A method as claimed in claim 14 including the step of rotating the front shoulder relative to the body and relative to the wall to move the front shoulder toward the wall.

16. A method as claimed in claim 14 including the step of forming an aperture in the wall.

17. A method as claimed in claim 14 including the step of rotating the faceplate relative to the body to engage the face plate with the body.
